(19) United States
(12) Patent Application Publication
(10) Pub. No.: US 2013/0112081 A1
(43) Pub. Date: May 9, 2013

(54) BEVERAGE DISPENSER WITH IMPROVED POWDER DOSING SYSTEM

(71) Applicants: Radboud Nelissen, Lausanne (CH); Richard Luke Murphy, Chagrin Falls, OH (US); Juan J. Gonzalez, St-Legier (CH); Ennio Bardin, Orbe (CH)

(72) Inventors: Radboud Nelissen, Lausanne (CH); Richard Luke Murphy, Chagrin Falls, OH (US); Juan J. Gonzalez, St-Legier (CH); Ennio Bardin, Orbe (CH)

(73) Assignee: NESTEC S.A., Vevey (CH)

(21) Appl. No.: 13/704,008

(22) PCT Filed: Jun. 15, 2011
(86) PCT No.: PCT/EP2011/059957

§ 371 Date: Dec. 13, 2012

(30) Foreign Application Priority Data
Jun. 16, 2010 (EP) 10166115.5

(51) Int. Cl. A47J 31/40

(52) U.S. Cl. CPC A47J 31/404
USPC 99/285; 99/289 R

(57) ABSTRACT

The invention concerns a dispensing machine for producing beverages from a beverage ingredient powder comprising:—at least one powder storing and dosing sub-assemblies, each of them comprising: a buffer tank able to be connected to a food or beverage ingredient powder container, a dosing device for metering a dose of a beverage ingredient powder,—reconstitution means for preparing a beverage from a dose of the food or beverage ingredient powder, wherein each of the buffer tank comprises a tube for guiding the powder from the container connection means to the dosing device, the first portion of said tube emerging on the doses device being vertical.

The present invention relates to device for metering and discharging accurately measured amounts of powder materials from a container storing the powder material, particularly for the preparation of beverages by dilution of metered doses of food soluble ingredients.

Various automated beverages or food dispensers for making hot or cold reconstituted products are known in the art. In a conventional beverage or food dispenser, a metered amount of water-soluble beverage-forming or food-forming powder supplied from a container, and a complementary metered amount of hot or cold water supplied from a water source are mixed and/or whipped to produce a hot, ambient or cold beverage or food, which is dispensed into a cup or glass. The powder can be stored in a canister that is a part of the dispenser and in which the operator regularly fills powder or the powder can be stored in a disposable cartridge that is regularly connected to the dispenser and then thrown away when they are emptied.

EP 2 123 201 describes such a beverage dispenser where soluble powder is drawn from suitable cartridges connected to the dispenser. Due to the simultaneous connection of different cartridges to the dispenser different beverages can be prepared according to the choice of the customer. For example the customer can select the preparation of a coffee or a decaffeinated coffee. In order to avoid an interruption in dispensing of beverages, due to shortage of powder, the beverage dispenser usually comprises a feeder hopper which receives a part of the powder from the cartridge and provides the metering means with this powder. Consequently, when the cartridge is emptied the hopper feeder still contains powder and beverages can be reproduced while a new cartridge can be installed.

Yet it has been observed that in such a beverage dispenser, the powder stored in the feeder hopper is not accurately dosed by the metering means. Actually the weight of the powder dose metered by the dosing means decreases with reducing powder levels within the cartridge. This trends progresses until the cartridge is emptied and the powder from the feeder hopper is released into the dosing means—at which point an increase in dose weight occurs.

The consistency of powder dosing is an important issue in the beverage dispensers because it influences the taste of the reconstituted beverage or food which becomes more diluted or concentrated. If the dispensing unit is set to dispense the target powder dose when the container is full, the concentration of the beverage or food will decrease as the level of the canister is emptied. If the powder dosing is set (time or speed) to dispense the target powder dose when the container is halfway or close to empty, then when the canister is refilled or reloaded the concentration of the beverage or food will be higher, yielding a more concentrated beverage or food. In terms of product quality, the consistency of the product is important for meeting the satisfaction of the consumer. If the dose-to-dose variation is too large, e.g., on the order of 5% of powder discrepancy or more, it affects the in-cup quality and the organoleptic properties of the product in a way that becomes perceptible for the consumer.

One aim of the present invention is to solve these problems by proposing a dispensing machine for producing beverages from a food or beverage ingredient powder comprising powder storing means and powder dosing means providing accurate doses of powder whatever the level of powder in the storing means.

According to a first aspect, the invention concerns a dispensing machine for producing beverages from a food or beverage ingredient powder comprising:
at least one powder storing and dosing sub-assembly comprising:
   a buffer tank able to be connected to a food or beverage ingredient powder container,
   a dosing device for metering a food or beverage ingredient powder
reconstitution means for preparing a beverage from a dose of the food or beverage ingredient powder,
   wherein the buffer tank consists in a tube for guiding the powder from the container to the dosing device, the first portion of said tube that emerges on the dosing device being vertical.

The storing and dosing sub-assembly of the dispensing machine is conceived for being connected to a food or beverage ingredient powder container. The dispensing machine of the present invention can comprise more than one powder storing and dosing sub-assembly. In that latter case, the different sub-assemblies can be connected to containers containing different types of powders. Preferably each powder storing and dosing sub-assembly presents the same configuration.

The buffer tank of the sub-assembly can present at its upper end connection means to connect a powder container. These connection means can be selected in the list of threaded means, snap means, sliding means. The connection can also be simply established by an engagement of the container outlet in the buffer tank opening.

The buffer tank simultaneously stores powder and guides powder from the container to the dosing device. The dosing device is usually placed at the bottom of the buffer tank so that powder flows from the container to the dosing device by gravity.

Preferably the first portion of the buffer tank tube presents a length greater than two times its section larger dimension. Usually this first portion of the buffer tank tube presents a cylindrical section and then its length is preferably greater than two times its diameter.

According to a specific embodiment the upper end of the buffer tank tube is vertically out of line with the bottom end of the buffer tank emerging on the dosing device. This embodiment can be implemented due to design constraints of the dispensing machine, particularly if the machine comprises at least two powder storing and dosing sub-assemblies.

The second portion of the buffer tank tube that connects the first portion of the tube to the powder container preferably presents a straight design. Generally, the second portion of the tube opens out from its bottom end to its upper end. Preferably, the inferior side of the second portion of the tube presents an angle a with the vertical of at most 40°, preferably at most 35°.

According to a preferred embodiment at least a part of the buffer tank tube can be made of stainless steel.

According to a specific embodiment at least a part of the buffer tank tube can be made of a transparent material. In this embodiment the dispensing machine preferably comprises an optical sensor at the level of the buffer tank.

In a second aspect the present invention also concerns a method to retrofit a beverage dispensing machine of the prior art by replacing the existing buffer tank by a buffer tank such as defined above consisting in a tube for guiding the powder from the container to the dosing device, the first portion of said tube that emerges on the dosing device being vertical.

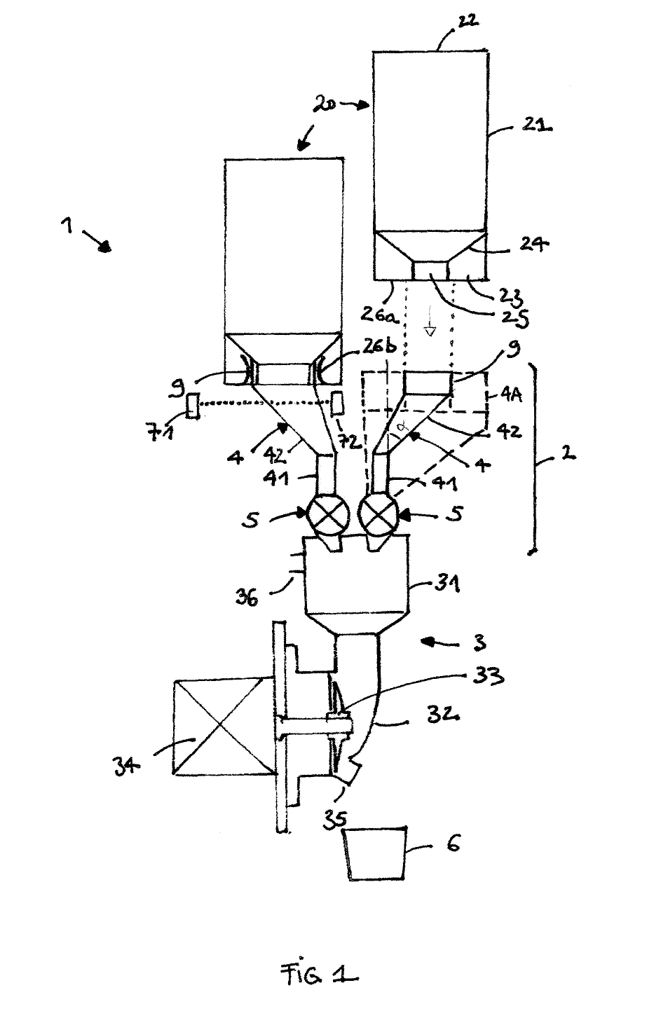

In the present specification, the terms “upper” and “bottom” and equivalents are used to describe the relational positioning of features of the invention. Thee both terms should be understood to refer to the buffer tank tube in its normal orientation into a dispensing machine for producing beverages as shown for example in FIG. 1.

### BRIEF DESCRIPTION OF THE DRAWINGS

The characteristics and advantages of the invention will be better understood in relation to FIG. 1 which is a schematic view of a dispenser of the present invention.

### DETAILED DESCRIPTION OF THE DRAWINGS

With reference to FIG. 1 the beverage dispenser 1 comprises two powder storing and dosing sub-assemblies 2 able to provide powder doses to common reconstitution means 3. Each of the powder storing and dosing sub-assemblies 2 comprises a buffer tank 4 able to be connected to a powder container 20.

The container 20 is usually a disposable cartridge that contains a soluble powder like for example coffee, decaffeinated coffee, dehydrated culinary products, chocolate or milk. Preferably the two containers 20 contain different powders. More preferably one contains coffee whereas the other contains decaffeinated coffee. The container comprises multiple doses of powder. The disposable container can be a container such as described in WO 2009/000810 and comprising a vessel 21 presenting a closed end 22 and an opened end 23, a hopper 24 placed inside the vessel and tapering to a discharge outlet 25 in direction of the vessel opened end, a tearable membrane 26a closing the hopper and the vessel. This type of container enables the refilling of the dispenser without loss of powder outside the buffer tank, because the tearable membrane is torn (illustrated as 26b in FIG. 1) while the container is being connected to the dispenser. Then the powder flows through the container hopper 24 directly in the buffer tank 4.

The dispenser comprises two dosing devices 5. In the illustrated embodiment, each of the dosing devices consists in a barrel closely integrated in a cylindrical chamber. The end of the drive shaft of the barrel can present coupling means able to be coupled to a drive motor in the base station. Each of the dosing devices is placed at the bottom of the buffer tanks 4 to receive the powder therefrom by gravity. The connection between a buffer tank and its corresponding dosing device should be such that the dosing device can be freely operated without being slowed down by e.g. friction means.

The upper end of each of the buffer tanks 4 of the beverage dispenser 1 is connected to the food or beverage ingredient powder container 20 so that the powder is able to flow from the container 20 to the buffer tank 4. The upper end of the buffer tank 4 can present connection means 9 to establish a connection with the container 20. If the disposable containers are containers such as described in WO 2009/000810, the connection means 9 can simply consist in a tube presenting a section smaller than the section of the opened end of the container vessel and bigger than the section of the hopper discharge outlet. Other connection means can be used depending on the type of container 20 that is used. The connection means can be a thread matching with a corresponding thread of the container 20 or a perforator for opening the container 20. the dispenser can also comprise fixing means (not represented) to lock the container 20.

The buffer tank 4 is a tube composed a first portion 41 emerging above the dosing device. This first portion is vertical and extends along a length that is at least greater than twice the diameter of the tube. The second portion 42 of the buffer tank is a tube linking the first vertical portion 41 to the powder container opening 25. The tube of this second portion opens out in direction of the powder container to match with its opening 25. Preferably the inferior side of the second portion of the tube 42 presents an angle a with the vertical of at most 35°.

On the contrary in the prior art illustrated in dotted lines, the buffer tank 4A was simply a hopper opening out from the dosing device 5 to the connection means 9.

The other parts of the dispensers—in particular the reconstitution means 3 for preparing a beverage from a dose of the food or beverage ingredient powder—are common to existing prior art. In FIG. 1 they encompass a mixing chamber 31 in which the dose of powder issued from a dosing device 5 is mixed with a diluent, usually water, introduced from a diluent inlet 36. The mixture is then introduced in a whipping chamber 32 comprising a whipper 33 before leaving the dispenser through an outlet 35 delivering the beverage in a cup 6. Other known reconstitution means can be implemented in relationship with the storing and metering subassembly of the present invention.

Optionally the dispenser can comprise sensor means 71, 72 able to detect the level of powder present in the buffer tank 4. The sensor is preferably an optical sensor comprising a transmitter and a receiver or a transmitter and a reflecting means. In this option, it is preferable that at least the part of the buffer tank 4 is transparent so that it can be crossed by the optical ray.

The beverage dispensing machine according to FIG. 1 was used to prepare coffee beverages. The coffee powder doses metered by the dosing devices were recovered before being mixed with the diluent so as to weight them and analyse the dosing accuracy of the storing and dosing sub-assemblies. The tests showed that 88% of doses metered by the dosing devices presented a dose-to-dose variation less than 5% of the average metered dose.

The same experiment made with the same coffee powder in a beverage dispensing machine according to FIG. 1 but with the buffer tank illustrated in dotted line showed that only 70% of the coffee powder doses metered by the dosing devices presented a dose-to-dose variation less than 5% with the average metered dose.

1. A dispensing machine for producing beverages from a beverage ingredient powder comprising:
at least one powder storing and dosing sub-assemblies, each of them comprising:
a buffer tank able to be connected to a food or beverage ingredient powder container,
a dosing device for metering a dose of a beverage ingredient powder,
a reconstitution member for preparing a beverage from a dose of the food or beverage ingredient powder, and
each of the buffer tanks comprises a tube for guiding the powder from a container connection to the dosing device, the first portion of the tube emerging on the dosing device being vertical.

2. A dispensing machine according to claim 1, wherein the first portion of the tube has a length that is greater than two times its section larger dimension.

3. A dispensing machine according to claim 1, wherein the upper end of the buffer tank tube is vertically out of line with the bottom end of the buffer tank emerging on the dosing device.

4. A dispensing machine according to claim 1, wherein a second portion of the buffer tank tube is straight.

5. A dispensing machine according to claim 1, wherein a second portion of the tube opens out from its bottom end to its upper end.

6. A dispensing machine according to claim 1, wherein an inferior side of a second portion of the tube presents an angle with a vertical of not greater than 40°.

7. A dispensing machine according to claim 1, wherein at least a part of the tube is made of stainless steel.

8. A dispensing machine according to claim 1, wherein at least a part of the tube is made of a transparent material.

9. A dispensing machine according to claim 1, wherein the dosing device is in a barrel closely integrated in a cylindrical chamber.
